(19) United States
(12) Patent Application Publication
(10) Pub. No.: US 2021/0389802 A1
(43) Pub. Date: Dec. 16, 2021

(54) LAPTOP DOCKING STATION

(71) Applicant: HUMANCENTRIC VENTURES LLC, Skokie, IL (US)

(72) Inventors: Alexey Tarelin, Evanston, IL (US); Simcha Kanter, Skokie, IL (US)

(73) Assignee: HUMANCENTRIC VENTURES LLC, Skokie, IL (US)

(21) Appl. No.: 17/335,215

(22) Filed: Jun. 1, 2021

Related U.S. Application Data
(63) Continuation-in-part of application No. 29/737,733, filed on Jun. 11, 2020, now Pat. No. D929999.

(51) Int. Cl. G06F 1/16; G06F 13/42

(52) U.S. Cl. CPC G06F 1/1632; G06F 2213/0042; G06F 13/4282

(57) ABSTRACT

A laptop docking station for laptops exhibiting asymmetrical top and bottom curve profiles and one or more connection ports on the left and/or right side edges.

### FIELD OF THE INVENTION

The invention relates to docking stations for laptop computers.

### BACKGROUND OF THE INVENTION

Undoubtedly, the laptop computer has become a standard tool for mobile and remote workers. Such devices allow one to work virtually anywhere using the integrated keyboard and display screen. When in a company or home office, however, some laptop users would prefer the additional comforts of a traditional desktop computer, e.g., a larger display, full-sized keyboard, and attached printer. Connection ports on the back and sides of most laptops allow such peripherals to be connected to the laptop.

Many users find, though, that connecting and disconnecting a plurality of connectors can become an inconvenient step in the processes of arriving or departing the office. Repeated connection and disconnections of the associated cables also present unnecessary wear on the connectors. From such concerns was born the laptop docking station.

A docking station for laptop computers refers to a peripheral which facilitates the connection of external connectors to a portable computer. Such docking stations usually contain electronic connectors integrated into the body of the docking station that mate with the ports on the docked device. Output ports on the main body of the docking station essentially replicate or multiply the ports on the laptop computer. The user can then attach connectors for external devices to the output ports of the docking station. Such docking stations are useful because they facilitate the easy insertion and removal of a laptop computer without the need to individually connect and disconnect cables for the external devices.

However, there are drawbacks to these technologies. For example, many of these technologies require the user to place the laptop computer flat on the desk surface even though the screen for the laptop computer remains unused when docked. This orientation occupies excessive work space on a desktop or table that might already provide support for other devices and peripherals.

Additionally, the placement of the port block or docking port in a conventional docking station is in a fixed position. This dictates that the laptop computer may only be inserted in one way and in one orientation even though ports may be available on the laptop computer in multiple locations along the back or sides of the device.

It would be beneficial if there was a laptop docking station that could connect with connection ports in a laptop from more than one orientation, especially on-end orientations that present connection ports along both of the lateral edges of the laptop.

Additionally, conventional laptop docking stations are usually limited to a configuration that works for only a single laptop computer. Such a design practice means that manufacturers must make, and merchants would have to carry in inventory, a large number of SKUs to address the vast number of laptops configurations, often from the same manufacturer.

It would be desirable to have a laptop docking station that would self-adjust in width to accommodate laptops of different case and display sizes, at least for models from the same manufacturer.

### SUMMARY OF THE INVENTION

Accordingly, embodiments of the invention are directed to a docking station for a laptop computer having an improved docking mechanism and modular connector interface that substantially obviates one or more of the problems due to limitations and disadvantages of the related art.

An object of embodiments of the invention is to provide a docking station with a carriage that has a prepositioned electrical connector which enables insertion of the laptop computer into the docking station with improved ergonomic convenience and better lateral stabilization while also reducing the work surface area taken up by the docking station.

Yet another object of embodiments of the invention is to provide a variable positioning mechanism that is capable of automatically positioning extending port connectors to align with the laptop computer port openings regardless of whether the laptop is inserted from the left or the right.

Yet another object of embodiments of the invention is to provide a responsive stabilization and positioning mechanism that can adapt to laptop computers of multiple sizes provided that the laptop model has similarly located port connections between models and display sizes.

Yet another object of embodiments of the invention is to provide an assistive release mechanism for the laptop computer to facilitate one-handed removal.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, a docking station for an laptop computer with improved connector interface includes a connector module for interfacing with the laptop computer, a plug on the connector module, a port on the connector module electrically connected to the first plug, and a stabilization base for holding the connector module and laptop computer in an upright position.

In particular, a docking station according to the present invention is well suited for a generally planar, portable computer having at least one port on a left or right edge of said computer, in which the docking station comprises:

(a) a support base; and

(b) a support receiver at said first position of said base, said receiver being dimensioned to receive and support the portable computer when said computer is inserted therein, said receiver further comprising:
(1) a receiving carriage having one or more connectors extending therefrom, said carriage and/or said one or more connectors being able to move laterally relative to said support receiver, and
(2) at least a pair of opposing contact members that contact opposing surfaces of a laptop computer inserted into the receiving carriage and then move in response to such contact to adjust a relative position of said carriage and/or said at least one connector so as to align the one or more connectors of said carriage with a corresponding connector port of said laptop.

The docking station according to the invention offers a stable platform to hold and support an inserted laptop computer with automatic connector alignment in a space-saving footprint. Particularly suited for laptops that offer at least one connection port on either side of the device in about the same location, and preferably two connection ports, on the edges of either side of the laptop even if the vertical distances to the connection ports is not the same down from the top of the laptop as they are up from the bottom. The present docking station automatically senses and corrects for the orientation of the inserted laptop thereby providing the user with greater comfort, convenience, and flexibility when using the present laptop docking station.

It is to be understood that both the foregoing general description and the following detailed description are exemplary and explanatory and are intended to provide further explanation of embodiments of the invention as claimed.

### BRIEF DESCRIPTION OF THE DRAWINGS

FIG. 1 is an isometric view of a docking station according to the invention.

FIG. 2 is a view showing a laptop oriented vertically on its rear edge in a guide channel of the docking station.

FIG. 3 is an edge view of a laptop, such as a MACBOOK PRO, having two connection ports in the left edge of the laptop that are at an asymmetric distance, i.e., the distance to the centerline of the connectors from the top of the laptop (the side with the display) is different from the distance to the bottom of the laptop (the CPU side).

FIG. 4 is a front view of a vertical receiver in the docking station showing contact members made of eccentric positioning cams on either side of the receiver and a pair of connectors at the rear of the receiver.

FIG. 5 is a top isometric view with directional arrows showing the direction of lateral carriage displacement for proper laptop port/carriage connector alignment as the eccentric cams in this embodiment rotate in response to their respective contacts with the top or bottom surfaces of an inserted laptop.

FIG. 6 is a sectional view of the eccentric cam operation as a laptop is inserted to align the laptop connection ports with the receiver carriage connectors.

FIG. 7 is a sectional view of the carriage position when the laptop has been fully inserted and the carriage laterally displaced based on independent detection of the top and bottom outside surfaces of the inserted laptop.

FIG. 8 shows a connector module having a set of connectors and ports connected by a flexible conduit.

FIG. 9 shows a detailed view of an offset cam and abutment member that shifts the receiver carriage to facilitate port-connector alignment.

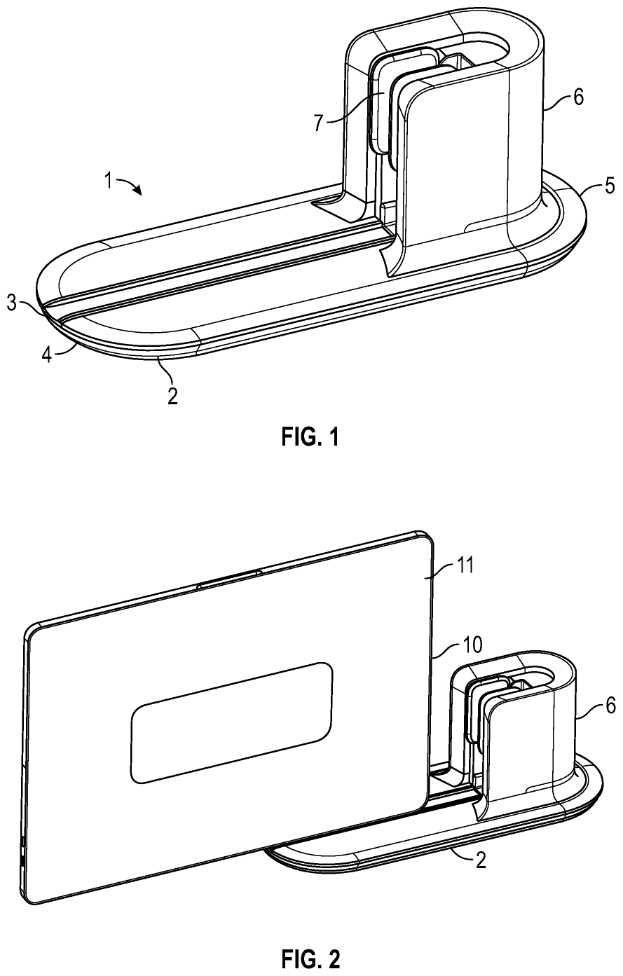

### DETAILED DESCRIPTION OF THE INVENTION

The laptop computer docking stations according to the present invention are particularly well suited to laptops that have: (a) asymmetrical top and bottom curve profiles about the laptop midplane so that the top curve profile (the side with the display) is different than the bottom curve profile (the side with the CPU), and (b) have at least one connection port on both the left and right side edges in substantially the same positions relative to the rear edge of the laptop. Such differences in the top and bottom edge surface profiles and similarities in the port locations provide a convenient way for the present docking station to receive the laptop and to detect the top and bottom surfaces of the laptop so as to relatively shift either the port connectors and/or the receiver into alignment with the ports on the laptop edge. Lateral stabilizers in the docking station receiver and a relatively wide base hold the laptop securely in position against tipping when inserted vertically. A spring-biased click-lock mechanism provides audible and tactile feedback to the user when the laptop has been fully inserted into the receiver. The same spring biasing helps the user to remove the laptop from the docking station by a spring-assisted ejection boost.

The port alignment system in the present invention relies on opposing contact members, such as rotatable cams, connected to abutment members on either side of the insertion channel of the receiver that act on a displaceable receiver carriage and/or the connector carrier. In a preferred embodiment, the contact members are rotatable cams.

If cams are used, the cams rotate horizontally about a vertical axis but are offset from their respective physical centers so that the cams each rotate in opposite, eccentric patterns that combine to move the receiver carriage and/or the connection port carrier laterally depending on the detected orientation of the inserted laptop. As the carriage and/or the connectors are moved relative to the incoming laptop, the connectors become aligned with one or more ports on the edge of the computer so that further insertion causes the receiver connectors to engage the laptop ports. The engaged ports then form a communication connection with the external ports on the receiver that are associated with the connectors of the receiver carriage.

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

As shown in the figures, docking station 1 includes a stabilization base 2 having an axially extended, central, guide channel 3 that extends from a front portion 4 of base 2 to a rear portion 5 of base 2. At rear portion 5 is a vertically upstanding receiver 6. Receiver 6 includes a movable carriage 7 with a connector module 8 presents or more protruding connectors 9 that will fit into the corresponding one or more connection ports 10 of an inserted laptop computer 11.

The connector module 8 includes one or more connectors 9 and one or more external ports 12 that are intended for substantially continuous connection with one or more desired peripheral devices regardless of whether laptop 11 is inserted into docking station 1 or not. The base member also includes a plurality of stabilization and alignment features.

One or more external ports 12 on the connector module 8 replicate the types of ports 10 on laptop computer 11. The external ports 12 are electrically connected to each of the connectors 9 so that electrical signals from one of the connectors 9 are passed through to one of the external ports 12. The connectors 9 and external ports 12 can be USB, MiniDisplay port, Firewire, VGA, DVI, HDMI, SATA, or other connector type.

The connectors 9 on the connector module 8 are positioned on module 8 to match the location of the ports on a predetermined range of laptop computers, e.g., the centerline horizontal distance between each adjacent connector and the centerline distance between the connectors and either the top or bottom of the laptop. The connector module 8 and moveable carriage 7 are sized and shaped to be inserted into the stabilization base, preferably when the docking station is manufactured for a fixed SKU for the chosen laptop or as a modular assembly that will receive various modules 8 that are each configured to receive a different type, brand, or style of mobile computer. The connector module 8 is generally oriented by enclosing it within a cavity 13 in the receiver 6.

Although the connector module 8 is generally secured within the receiver 6 of stabilization base 2, it is allowed a range of motion within base 2 to enable alignment with the laptop computer when inserted. The alignment and stabilization features on the carriage make contact with the laptop computer when it is inserted and shift the connectors and/or laptop laterally to the correct location to mate with the laptop computer ports regardless of whether the laptop is inserted topside out or topside back. The port or ports on either side will become aligned and connected.

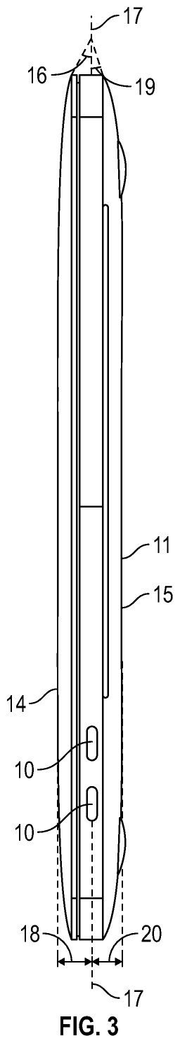

Any of the MACBOOK PRO line of computers from Apple Inc. in Cupertino, Calif. represents a preferred type of laptop computer for use with a preferred embodiment of the present invention. See FIG. 3. These laptops are designed with two of the same type of ports 10 on either side of the machine, at substantially the same distance from the rear edge, and substantially the same distance between ports.

The top, outer surface 14 of the laptop screen curves to the cover center from the peripheral edge of laptop 11 at a first tangential angle 16 relative to horizontal centerline axis 17 of computer 11 to a first height 18 from centerline axis 17.

The bottom, outer surface 15 of laptop 11 also curves toward the bottom center from the peripheral edge of laptop 11 but at a second tangential angle 19 relative to centerline 17 that differs from first angle 16. The bottom, outer surface 15 extends to a second height 20 that differs from first height 18.

The difference between tangential angles 16 and 19 is substantially consistent among the various screen sizes of the MACBOOK PRO line of laptops. This provides a pleasing visual aesthetic to the product line. It also means that these angles can be mechanically detected and used to shift a carriage bearing the corresponding connectors to correspond to the location of the corresponding ports on the inserted laptop.

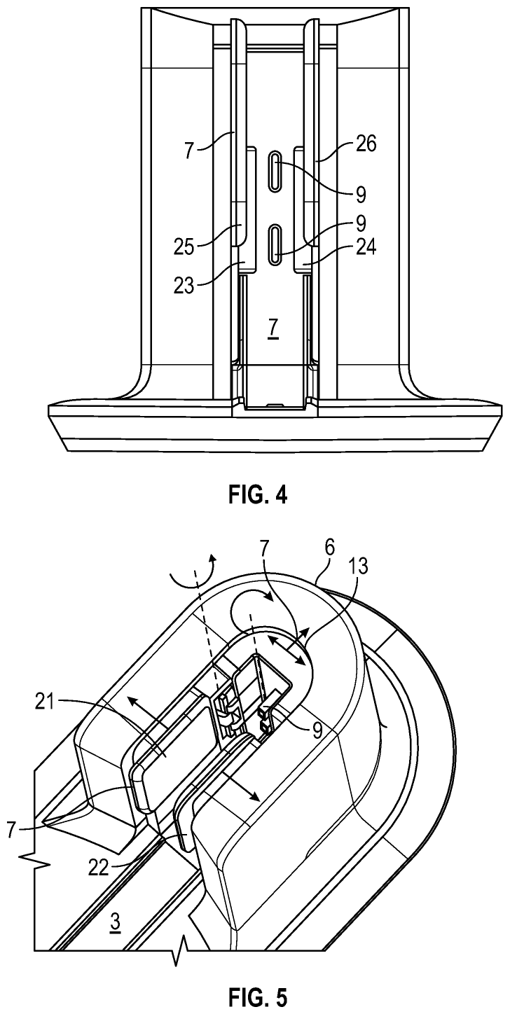

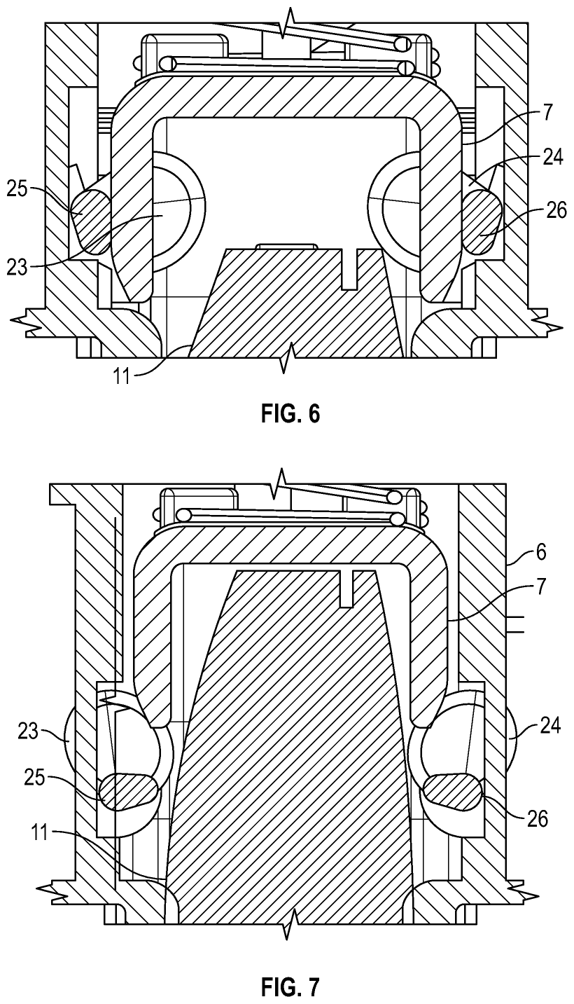

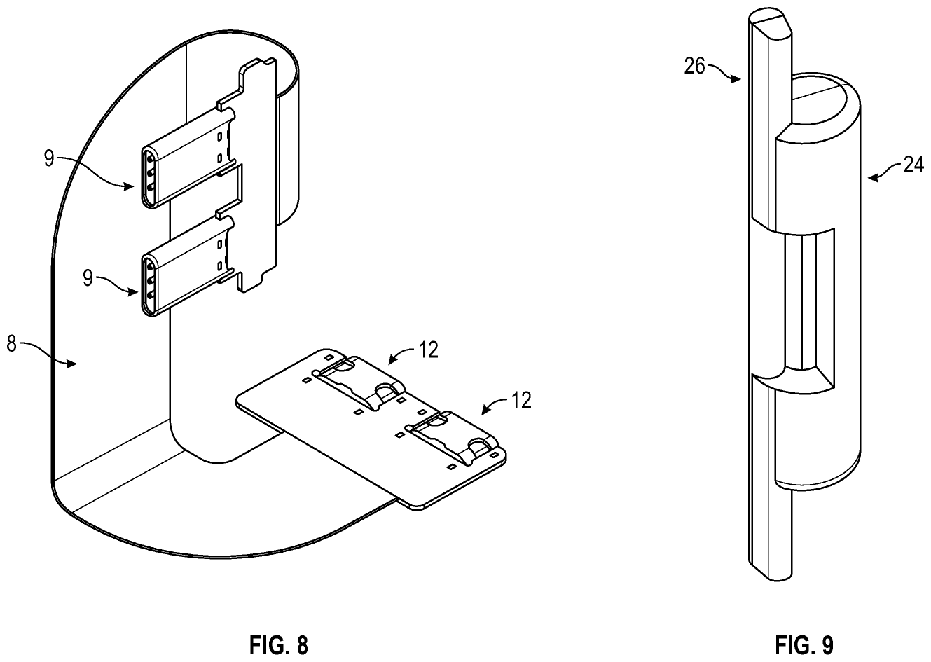

As shown in more detail in FIGS. 4-7, first and second lateral stabilizers 21, 22 are spring-biased towards guide channel 3. An inserted laptop presses against stabilizers 21, 22 urging both outwardly to accommodate the height of laptop 11 (i.e., the width of the device when inserted vertically) in receiver 6. As the laptop continues to be inserted, the leading edges of top surface 14 and bottom surface 15 engage first and second positioning contact members, such as cams 23, 24 with vertically-extended, first and second abutment members 25, 26. Cams 23, 24 rotate about a vertical axis but offset from center of rotation so that cams 23, 24 rotate eccentrically. Each of cams 23, 24 can independently contact the leading edge of laptop surface 14, 15 and rotate as the laptop is extended into the rear of receiver 6. The rotation of cams 23, 24 cause abutment members 25, 26 to press against the corresponding outside surface of laptop 11 and move carriage 7 laterally to align connectors 9 with laptop ports 10. Contact members that are not cams can present angled surfaces that contact and slide over the outer surface of the inserted laptop as each is displaced laterally in relation to the detected surface and thereby relatively move the receiver carriage 7 and/or connector module 8 relatively laterally to align one or more connectors 9 of receiver 6 with one or more ports 10 of laptop 11.

Once the laptop ports 10 are engaged with connectors 9, carriage 7 continues to move back so that space is cleared for cams 23, 24 and abutment members 25, 26 to move out of the way of the laptop.

The moveable carriage 7 is separated from the rear of the stabilization receiver 6 with springs which are compressed when the user presses the laptop computer 11 into receiver 6. When the connectors 9 fully engage with the corresponding ports 10 on laptop computer 11, the laptop 11 is releasably retained by receiver 6 but when the user pulls on laptop 11, the springs assist the user by providing an ejection force to remove laptop 11 from receiver 6.

It will be understood that the foregoing represents a preferred embodiment of the present invention and is not intended to limit the scope of the appended claims.

What is claimed is:

1. A docking station for a generally planar, portable computer having at least one port on a left or right edge of said computer, said docking station comprising:
(a) a supporting base; and
(b) a support receiver at said first position of said base, said receiver being dimensioned to receive and support the portable computer when said computer is inserted therein, said receiver further comprising:
(1) a receiving carriage having one or more connectors extending therefrom, said carriage and/or said one or more connectors being able to move laterally relative to said support receiver, and
(2) at least a pair of opposing contact members that contact opposing surfaces of a laptop computer inserted into the receiving carriage and then move in response to such contact to adjust a relative position of said carriage and/or said at least one connector so as to align the one or more connectors of said carriage with a corresponding connector port of said laptop.

2. A docking station according to claim 1 wherein said carriage has two connectors.

3. A docking station according to claim 2 wherein at least one of said connectors is a USB-C connector.

4. A docking station according to claim 1 wherein at least one of the laptop connector port is located on an edge of said laptop between a top surface and a bottom surface of said laptop but not evenly centered therebetween.

5. A docking station according to claim 1 wherein said receiver engages the laptop with an audible indicator when said laptop is fully inserted.

6. A docking station according to claim 1 wherein said receiver further comprises an axially displaceable connector cover that exposes the at least one connector when said cover is axially displaced toward said first portion of said base.

7. A docking station according to claim 1 wherein said contact members comprise rotatable cams.

8. A docking station according to claim 7 wherein said cams rotate in response to contact with an inserted laptop having asymmetrical top and bottom curve profiles about its vertical midplane so that the top curve profile is different than the bottom curve profile.

9. A docking station according to claim 8 wherein said inserted laptop comprises (b) connection ports on both left and right side edges of said laptop in substantially the same positions relative to the rear edge of the laptop.

10. A docking station according to claim 1 wherein said carriage further comprises an axially-extended guide channel from said receiver to a front of said base.
